(19) United States
(12) Patent Application Publication
(10) Pub. No.: US 2009/0274065 A1
(43) Pub. Date: Nov. 5, 2009

(54) METHOD AND APPARATUS FOR SETTING WIRELESS LOCAL AREA NETWORK BY USING BUTTON

(75) Inventors: Ho Jin, Yongin-si (KR); Young-chul Sohn, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/263,526

(22) Filed: Nov. 3, 2008

(30) Foreign Application Priority Data
May 1, 2008 (KR) 10-2008-0041056

(51) Int. Cl. H04W 84/12; H04L 12/28

(52) U.S. Cl. 370/254

(57) ABSTRACT

A method and apparatus for setting a wireless local area network (LAN) based on manipulating a button is provided. In the method, an existing wireless network links with a network that supports a wireless security setup. The method includes storing setup information about a currently associated wireless network if the currently associated wireless network exists, and performing the wireless security setup of the network that supports the wireless security setup, according to the stored information about the currently associated wireless network.

### CROSS-REFERENCE TO RELATED PATENT APPLICATION

This application claims priority from Korean Patent Application No. 10-2008-0041056, filed on May 1, 2008 in the Korean Intellectual Property Office, the disclosure of which is incorporated herein in its entirety by reference.

### BACKGROUND OF THE INVENTION

1. Field of the Invention

Methods and apparatuses consistent with the present invention relate setting a wireless local area network (LAN), and more particularly, to setting a wireless LAN by manipulating a button which links with an existing wireless LAN.

2. Description of the Related Art

Generally, in a wireless LAN comprises, data is transmitted or received according to wireless frequency technology without any cable connection. Current wireless LANs generally follow the IEEE 802.11 standard.

A wireless LAN system includes a Wireless Fidelity (WiFi) terminal and an access point (AP).

The WiFi protected setup (WPS) standard is an authentication program that uses a standard method in order to allow users to easily and quickly set encryption security on network WiFi devices.

The WPS standard supports security setup, and supports wireless LAN setup for apparatuses incapable of character input actions. Modes of the WPS standard are classified into a push button configuration (PBC) mode, a personal identification number (PIN) mode, a universal serial bus (USB) mode, and a near field communication (NFC) mode.

For example, in a method of automatically setting a wireless LAN by using a PBC mode of the WPS standard, first, a WPS PBC button of one of an AP and a wireless LAN terminal is operated. Then, a WPS PBC button of the other device is pressed within two minutes from when the WPS PBC button was operated. However, if WPS PBC actions of two or more APs are performed simultaneously, networking between apparatuses cannot be performed.

Accordingly, the WPS PBC mode allows apparatuses to establish a wireless network without needing to input service set identifiers (SSIDs) and security keys.

FIG. 1 illustrates communication between a conventional legacy network 110 and a WPS network 120.

In order to perform WPS in a legacy wireless LAN (WLAN) setup mode, an AP 130 should be able to simultaneously perform legacy WLAN setup and WPS.

When security levels of an existing network and a network that is to be newly connected are different from each other, the following problems occur.

First, when WLAN apparatuses 112 and 114 in a legacy WLAN operate in a wireless setup mode in which security has not been set, the WLAN apparatuses 112 and 114 cannot communicate with a security-set WPS terminal 122 in a PBC mode of the WPS.

Second, when security levels of the WLAN apparatuses 112 and 114 in the legacy WLAN are lower than that of the WPS terminal 122, the WLAN apparatuses 112 and 114 cannot communicate with the WPS terminal 122 because the security levels of the WLAN apparatuses 112 and 114 are different from that of the WPS terminal 122.

In order for the WPS terminal 122 to support a WPS security key without user intervention, the AP 130 should generate a new security key for the WPS network 120.

Thus, an existing 802.11 legacy wireless network requires an improved WPS wireless LAN setup in order to associate with a WPS wireless network.

### SUMMARY OF THE INVENTION

The present invention provides a method of setting a wireless LAN based on manipulating a button which links with an existing wireless LAN, in order to perform efficient communication between a legacy wireless LAN apparatus and a WPS apparatus.

The present invention also provides an apparatus for setting the wireless LAN based on manipulating a button.

According to an aspect of the present invention, there is provided a wireless LAN setting method by which an existing wireless network links with a network that supports a wireless security setup, the method comprising: storing setup information about a currently associated wireless network if the currently associated wireless network exists; and performing wireless security setup of the network that supports the wireless security setup, according to the stored information about the currently associated wireless network.

According to another aspect of the present invention, there is provided a wireless LAN setting method by which an existing wireless network links with a network that supports a wireless security setup without changing information about the existing wireless network, the method comprising: storing an identifier of a currently associated wireless network if the currently associated wireless network exists; generating a security level and a security key at a user's request; and performing the wireless security setup by using the stored identifier of the currently associated wireless network and the generated security level and security key.

According to another aspect of the present invention, there is provided a wireless LAN setting method by which an existing wireless network is relayed with a network that supports a wireless security setup, the method comprising: storing network information about apparatuses connected to one another via a wireless network; converting a security setup of a packet received via the wireless network into a security setup of a destination network by referring to the network information about the connected apparatuses; and re-transmitting a packet changed according to the security setup of the destination network to the destination network.

According to another aspect of the present invention, there is provided a method of setting a wireless LAN setup of an apparatus that supports a wireless security setup, the method comprising: randomly generating a service identifier at a user's request made by pressing a button; randomly generating a security key if the generated service identifier is not a duplicate, by scanning wireless LAN apparatuses with which the apparatus that supports the wireless security setup can associate; and performing the wireless security setup by using the service identifier and the security key.

According to another aspect of the present invention, there is provided an apparatus for setting a wireless LAN setup of an apparatus that supports a wireless security setup, the wireless LAN setting apparatus comprising: an input unit inputting a user's selection for the wireless LAN setup by using a button; a storage unit storing network setup information about apparatuses networked with one another; and a wireless LAN control unit performing the wireless LAN setup based on manipulating a button, according to information about a setup of an existing network, which is stored in the storage unit, and generating a security level and a security key at a user's request and performing the wireless LAN setup based on manipulating a button by using a service identifier of the existing network, which is stored in the storage unit, and the security level and the security key, when receiving a request for the wireless LAN setup through the input unit.

### BRIEF DESCRIPTION OF THE DRAWINGS

The above and other aspects of the present invention will become more apparent by describing in detail exemplary embodiments thereof with reference to the attached drawings in which:

FIG. 1 illustrates communication between a conventional legacy network and a WPS network;

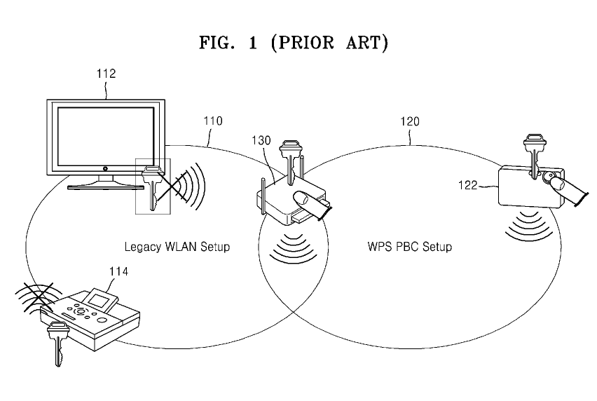

FIG. 2 is a block diagram of an AP for a wireless local area network (LAN) setup, according to an exemplary embodiment of the present invention;

FIG. 3 illustrates a wireless LAN system which links an existing wireless network with a WPS network, according to an exemplary embodiment of the present invention;

FIG. 4 is a flowchart illustrating implementation of the wireless LAN system illustrated in FIG. 3;

FIG. 5 illustrates a wireless LAN system which performs a new WPS while maintaining a wireless LAN setup of an existing network, according to an exemplary embodiment of the present invention;

FIGS. 6A and 6B are flowcharts illustrating implementation of the wireless LAN system illustrated in FIG. 5;

FIG. 7A is a flowchart illustrating implementation of a bridging function of an AP of the wireless LAN system illustrated in FIG. 5;

FIG. 7B illustrates a network information management table which is managed by the AP of the wireless LAN system illustrated in FIG. 5;

FIG. 8 illustrates a wireless LAN system in which an AP automatically performs WPS, according to an exemplary embodiment of the present invention; and

FIG. 9 is a flowchart illustrating implementation of the wireless LAN system illustrated in FIG. 8.

### DETAILED DESCRIPTION OF EXEMPLARY EMBODIMENTS OF THE INVENTION

The present invention will now be described more fully with reference to the accompanying drawings, in which exemplary embodiments of the invention are shown.

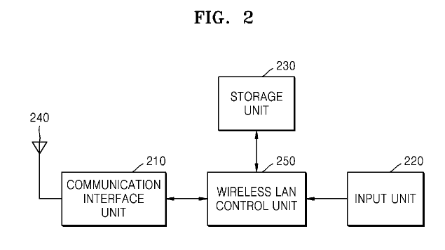

FIG. 2 is a block diagram of an access point (AP) for a wireless local area network (LAN) setup, according to an exemplary embodiment of the present invention. Referring to FIG. 2, the AP includes a communication interface unit 210, an input unit 220, a storage unit 230, an antenna 240, and a wireless LAN control unit 250.

The communication interface unit 210 demodulates data received from a wireless communication apparatus and modulates data which is to be transmitted to the wireless communication apparatus.

The input unit 220 is a key pad, a touch screen, or the like, and includes a plurality of number/character input keys, a function key for interfacing with users, a call key, and other keys. In particular, the input unit 220 includes a WPS button for selecting a wireless LAN setup of a push button configuration (PBC) mode of a WPS.

The storage unit 230 is a Read Only Memory (ROM), a voice memory, or the like for storing a plurality of programs and data. In particular, the storage unit 230 stores a network management table for managing network information about apparatuses networked with one another. The network management table includes network information, such as service set identifiers (SSIDs), medium access control (MAC) information, security levels, security keys of the apparatuses networked with one another, whether the networked apparatuses are in sleep modes, and whether the networked apparatuses support the WPS.

The antenna 240 is used to receive data from a wireless LAN terminal and transmit data to the wireless LAN terminal.

In response to receiving a request for wireless LAN setup from the input unit 220, the wireless LAN control unit 250 performs a WPS PBC mode according to information about a setup of an existing network, or generates a security level and a security key at a user's request and performs a WPS PBC mode by using an SSID of the existing network, which is stored in the storage unit 230, and the security level and the security key.

The wireless LAN control unit 250 converts a security setup of a packet received via a wireless network into a security setup of a destination network by referring to the network information about the networked apparatuses, which is stored in the storage unit 230, and re-transmits the packet to the destination network by referring to the security setup of the destination network.

The wireless LAN control unit 250 randomly generates an SSID and a security key at a user's request for WPS, which has been made by pressing a button, and performs WPS by using the SSID and the security key.

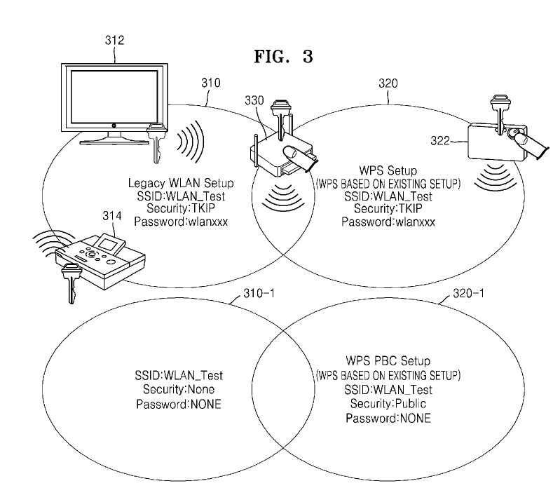

FIG. 3 illustrates a wireless LAN system which links an existing legacy network 310 with a WPS network 320, according to an exemplary embodiment of the present invention;

Referring to FIG. 3, an AP 330 sets a new WPS PBC mode for linking the legacy network 310 with the WPS network 320. In other words, the AP 330 sets a wireless LAN so that apparatuses 312 and 314, which are associated with the legacy network 310, have the same SSIDs and security levels as those of a WPS apparatus 322 which is associated with the WPS network 320.

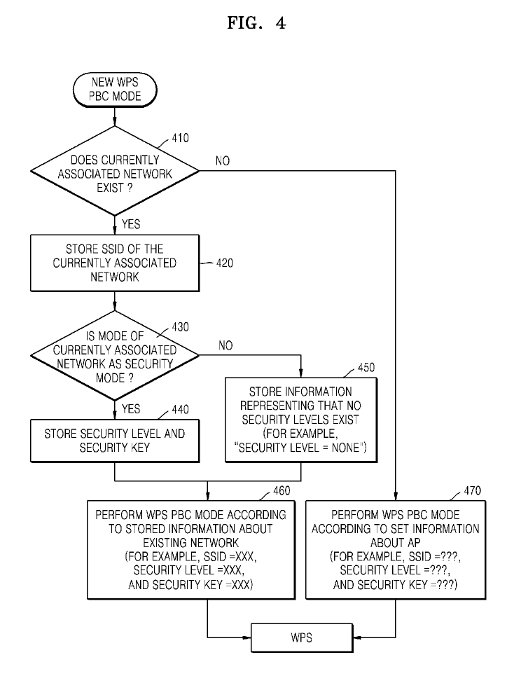

FIG. 4 is a flowchart illustrating implementation of the wireless LAN system illustrated in FIG. 3.

First, in operation 410, when a WPS PBC mode is requested by manipulating a button, it is determined with reference to network setup information whether a currently associated network exists.

Then, in operation 420, when it is determined that the currently associated network exists, an SSID of the currently associated network is stored. On the other hand, when it is determined that no currently associated networks exist, a WPS PBC mode is performed according to set information about an AP (for example, SSID=???, security level=???, and security key=???), in operation 470.

After operation 420, it is determined with reference to the network setup information whether the mode of the currently associated network is set as a security mode, in operation 430.

If it is determined that the mode of the currently associated network is set as the security mode, a security level and a security key are stored, in operation 440. On the other hand, if it is determined that the mode of the currently associated network is not set as the security mode, information representing that no security levels exist (for example, “security level=None”) is stored, in operation 450.

Then, in operation 460, a WPS PBC mode is performed according to stored information about the currently associated network (for example, SSID=xxx, security level=xxx, and security key=xxx).

When security has been set in the currently associated network, a WPS PBC mode is performed by using the SSID, security level, and security key of the currently associated network without any changes.

As illustrated in FIG. 3, it is assumed that the existing legacy network 310 uses a Temporal Key Integrity Protocol (TKIP) as a security level and sets a security key (or a password) as “wlan_xxx”. In this case, the AP 330 performs a WPS PBC mode by using the TKIP and security key which have been used in the existing legacy network 310, although the WPS apparatus 322 supports various security levels (for example, an Advanced Encryption Standard (AES), the TKIP, and Wired Equivalent Privacy (WEP)).

As illustrated in FIG. 3, when no securities have been set in an existing network 310-1, the AP 330 performs a WPS PBC mode by using only an SSID of the existing network 310-1 without setting security in the existing network 310-1.

When security setup of a WPS network does not support a security setup of an existing network, an apparatus in the existing network 310-1 cannot communicate with an apparatus in the WPS network 320-1 because security setups in the existing network 310-1 and the WPS network 320-1 cannot be identical to each other.

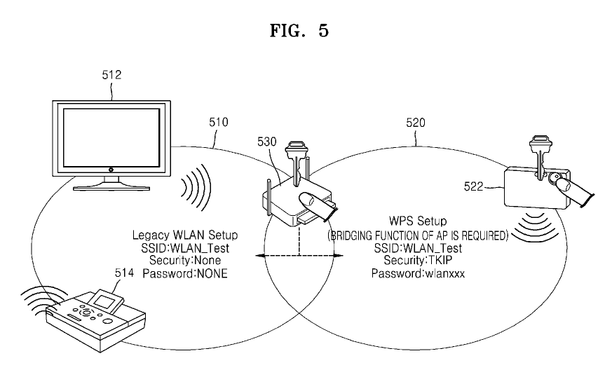

FIG. 5 illustrates a wireless LAN system which performs a new WPS while maintaining a wireless LAN setup of an existing legacy network 510, according to an exemplary embodiment of the present invention.

Referring to FIG. 5, an AP 530 sets a new WPS PBC mode for linking the existing legacy network 510 with a WPS network 520. In other words, the AP 530 uses only an SSID of the existing legacy network 510 and newly generates a security level and a security key. In addition, the AP 530 performs a bridge function so that apparatuses 512 and 514 associating with the existing legacy network 510 can communicate with a WPS apparatus 522 which is associated with the WPS network 520.

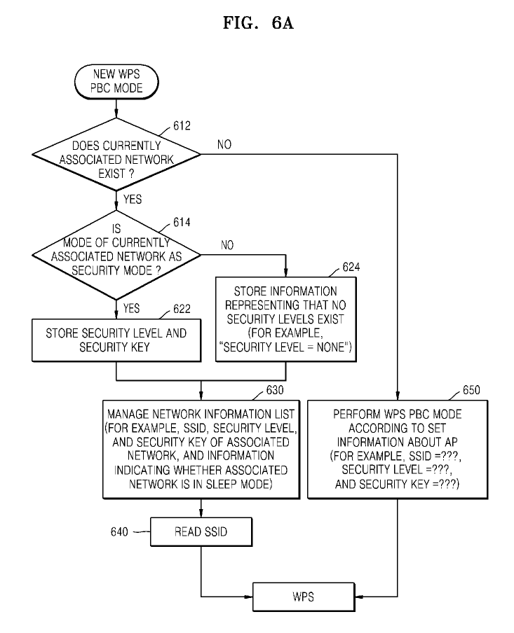

FIGS. 6A and 6B are flowcharts illustrating implementation of the wireless LAN system illustrated in FIG. 5.

FIG. 6A is a flowchart illustrating a preprocessing process for new security setup in the AP 530.

First, in operation 612, when a WPS PBC mode is requested, it is determined by referring to network setup information whether a currently associated network exists. If it is determined that no currently associated networks exist, a WPS PBC mode is performed according to set information about the AP 530 (for example, SSID=???, security level=???, and security key=???), in operation 650.

On the other hand, when it is determined that the currently associated network exists, it is determined whether the mode of the currently associated network is set as a security mode, in operation 614.

If it is determined that the mode of the currently associated network is set as the security mode, a security level and a security key are stored, in operation 622. On the other hand, if it is determined that the mode of the currently associated network is not set as the security mode, information representing that no security levels exist (for example, “security level=None”) is stored, in operation 624.

Then, in operation 630, a network information list associated with the associated network is managed. The network information list may include an SSID, a security level, and a security key of the associated network, and information indicating whether the associated network is in a sleep mode.

Then, in operation 640, a WPS PBC mode is performed by reading and using only an SSID of the currently associated network.

FIG. 6B illustrates the operation 640 of performing WPS by using only the SSID of the existing network.

First, in operation 662, the SSID of the existing network is set as an SSID for a new WPS.

Then, in operation 664, a security level and a security key of the AP 530 are newly set. For example, the security level is determined through communication with an associated WPS apparatus. The security key is dynamically/randomly generated using a random number or a random text.

Then, when it is determined in operation 666 that the WPS has been completed using the set SSID, the set security level, and the set security key, a packet transmission service is performed according to the WPS, in operation 668.

Accordingly, in a newly-improved WPS mode, the apparatuses 512 and 514 associating with the existing legacy network 510 can communicate with the WPS apparatus 522 which is associated with the WPS network 520 by using the SSID of the existing legacy network 510 and the automatically generated security level and security key without changing information about the existing legacy network 510.

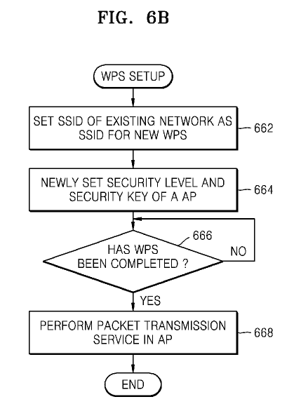

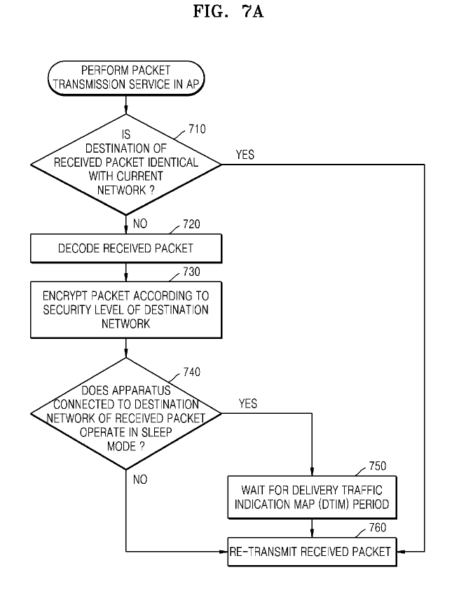

FIG. 7A is a flowchart illustrating implementation of a bridging function of the AP 530 of the wireless LAN system illustrated in FIG. 5.

First, the AP 530 manages a network information list associated with the associated network by using a network information management table illustrated in FIG. 7B.

Then, when a packet transmission service starts, the WPS network 520 (for example, 11:BE:43:4F:32:23) transmits a message “Hello” to the legacy network 510 (for example, 02:AE:33:4F:52:31) via the AP 530. At this time, according to the network information management table illustrated in FIG. 7B, an MAC address of the WPS network 520 is set as “11:BE:43:4F:32:23” and an MAC address of the existing legacy network 510 is set as “02:AE:33:4F:52:31”.

Then, the AP 530 receives a packet encrypted with a security level of a TKIP from the WPS apparatus 522.

Thereafter, in operation 710, the AP 530 determines whether a destination of the received packet is a network identical to a current network.

Next, if the destination of the received packet is not a network identical to the current network, the AP 530 decodes the received packet by using a security level of the TKIP, in operation 720.

Then, in operation 730, the AP 530 encrypts the packet with WEP corresponding to the security level of the destination network. In other words, the AP 530 changes the security setup of the packet received via a wireless network into the security setup of the destination network by referring to network information about the associated apparatuses.

Thereafter, if it is determined in operation 740 that an apparatus connected to the destination network of the received packet does not operate in a sleep mode, the AP 530 re-transmits the received packet to the existing legacy network 510 corresponding to the destination network, in operation 760. On the other hand, if it is determined in operation 740 that the apparatus connected to the destination network of the received packet operates in the sleep mode, the AP 530 waits for a delivery traffic indication map (DTIM) period in operation 750 and re-transmits the received packet to the existing legacy network 510 corresponding to the destination network, in operation 760.

Accordingly, due to the bridging operation of the AP 530, the apparatuses that associate with the legacy network 510 can communicate with the WPS apparatus 522 that associates with the WPS network 520 without changing the network setup in a web page of the AP 530.

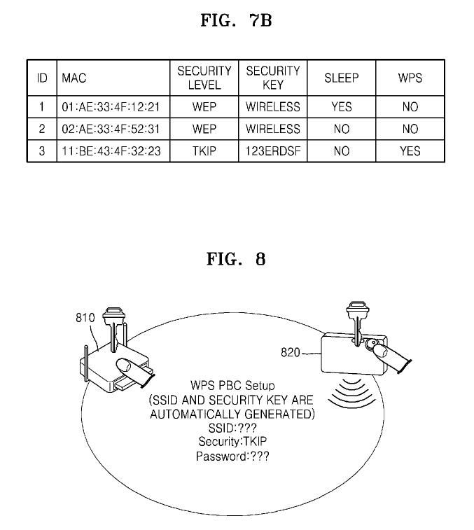

FIG. 8 illustrates a wireless LAN system in which an AP 810 automatically performs WPS, according to an exemplary embodiment of the present invention.

Referring to FIG. 8, the AP 810 automatically generates a new SSID and a new security key at a user's request that is made by pressing a button. Accordingly, the AP 810 communicates with the WPS apparatus 820 by using the automatically generated SSID and security key.

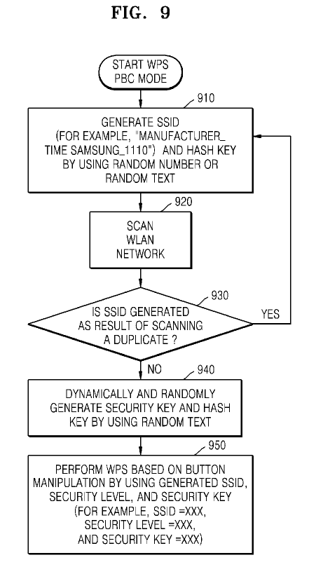

FIG. 9 is a flowchart illustrating implementation of the wireless LAN system illustrated in FIG. 8.

First, in operation 910, when a WPS PBC mode starts at a user's request made by pressing a button, the AP 810 generates an SSID and a hash key by using a random number or a random text. For example, the SSID may be generated as “manufacturer_Time Samsung_{—}1110” by using the random number.

Then, in operation 920, the AP 810 scans wireless LAN devices with which the AP 810 can associate.

In operation 930, the AP 810 scans the wireless LAN devices with which the AP 810 can associate, in order to determine whether the generated SSID is a duplicate. In other words, if the generated SSID is identical to one of SSIDs of the scanned wireless LAN devices, operations 910 and 920 are performed again so as to generate an SSID that is not identical to the SSIDs of the scanned wireless LAN devices.

On the other hand, if the generated SSID is not identical to one of SSIDs of the scanned wireless LAN devices, the AP 810 dynamically and randomly generates a security key and a hash key by using the random text, in operation 940.

Then, in operation 950, the AP 810 performs a WPS PBC mode by using the generated SSID, security level, and security key.

As a result, during generation of a WPS network, the AP 810 can automatically support security setup without the user inputting the security setup, by automatically setting a security key.

In other exemplary embodiments, a wireless LAN terminal may replace the AP 810. In other words, a wireless LAN terminal can establish an ad-hoc network with other wireless terminals without the help of an AP by automatically generating a unique SSID and a unique security key through a process as illustrated in FIG. 9.

As described above, in the exemplary embodiments of the present invention, an existing 802.11 wireless LAN apparatus and a WPS wireless LAN apparatus share an SSID and a security level, thereby supporting compatibility between the existing 802.11 wireless LAN apparatus and the WPS wireless LAN apparatus. For example, if a PC or a printer belongs to a general wireless LAN and a camera or an MP3 player belongs to a WPS network, the PC/printer can seamlessly communicate with the camera/MP3 player by using a PBC mode of WPS.

In addition, by installing a bridging function in an AP, a legacy network can still communicate with a WPS network without changing network setup in a wireless LAN setup page of the AP. Moreover, during generation of the WPS network, the AP can automatically support security setup for wireless LAN setup without a user inputting a security setup, by automatically setting a security key.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. The invention can also be embodied as computer readable codes transmitted via carrier waves (such as data transmission through the Internet).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A wireless local area network (LAN) setting method by which a currently associated wireless network links with a network that supports a wireless security setup, the method comprising:
if it is determined that the currently associated wireless network exists, storing setup information about the currently associated wireless network; and
performing wireless security setup of the network that supports the wireless security setup, according to the stored information about the currently associated wireless network.

2. The wireless LAN setting method of claim 1, wherein if no securities have been set in the existing wireless network, a wireless LAN setup is performed using only an identifier of the existing wireless network in response to manipulating a button.

3. The wireless LAN setting method of claim 1, wherein if a WiFi protected setup network supports a security setup level of the existing wireless network, the wireless security setup is performed using the identifier, a security level, and a security key of the existing wireless network.

4. The wireless LAN setting method of claim 1, if no currently associated wireless networks exist, further comprising performing wireless LAN setup based on manipulating a button according to set network information.

5. A wireless local area network (LAN) setting method by which a currently associated wireless network links with a network that supports a wireless security setup without changing information about the existing wireless network, the method comprising:
if the currently associated wireless network exists, storing an identifier of the currently associated wireless network;
generating a security level and a security key in response a user's request; and
performing the wireless security setup by using the stored identifier of the currently associated wireless network and the security level and the security key which are generated.

6. The wireless LAN setting method of claim 5, wherein the security level is determined through communication with an apparatus for setting a wireless LAN by manipulating a button.

7. The wireless LAN setting method of claim 5, wherein the security key is dynamically and randomly generated using one of a random number and a random text.

8. A wireless local area network (LAN) setting method by which an existing wireless network is relayed with a network that supports a wireless security setup, the method comprising:
storing network information about apparatuses connected to one another via a wireless network;
converting a security setup of a packet received via the wireless network into a security setup of a destination network by referring to the network information about the apparatuses; and
re-transmitting a packet changed according to the security setup of the destination network to the destination network.

9. The wireless LAN setting method of claim 9, further comprising, after the storing the network information about the apparatuses, forming a network information management table for managing a network information list.

10. The wireless LAN setting method of claim 8, wherein the converting the security setup of the packet into the security setup of the destination network comprises:
decoding the packet by using a security level of the packet; and
encrypting the decoded packet by using a security level for an address of the destination network.

11. The wireless LAN setting method of claim 8, further comprising, after the encrypting of the decoded packet, waiting for a predetermined period of time and re-transmitting the packet if it is determined that an apparatus belonging to the destination network of the packet operates in a sleep mode.

12. A method of setting a wireless local area network (LAN) setup of an apparatus that supports a wireless security setup, the method comprising:
randomly generating a service identifier in response to a user's request made by manipulating a button;
scanning wireless LAN apparatuses with which the apparatus that supports the wireless security setup can associate, and randomly generating a security key if the generated service identifier is not identical to a service identifier of one of the wireless LAN apparatuses; and
performing the wireless security setup by using the generated service identifier and the security key.

13. The method of claim 12, further comprising generating a hash key in response to the user's request.

14. The method of claim 13, wherein the service identifier and the hash key are dynamically and randomly generated using one of a random number and a random text.

15. An apparatus for setting a wireless local area network (LAN) setup of another apparatus that supports a wireless security setup, the apparatus comprising:
an input unit through which a user's selection for the wireless LAN setup is input by manipulating a button;
a storage unit which stores network setup information about apparatuses networked with one another; and
a wireless LAN control unit which performs the wireless LAN setup in response to manipulation of the button, according to information about a setup of an existing network, which is stored in the storage unit, and generates a security level and a security key at a user's request and performs the wireless LAN setup in response to manipulation of the button by using a service identifier of the existing network, which is stored in the storage unit, and the security level and the security key, in response to receiving a request for the wireless LAN setup through the input unit.

16. The apparatus of claim 15, wherein the wireless LAN control unit encrypts a received packet according to a security setup of a destination network by referring to the network setup information about the networked apparatuses, and re-transmits the packet to the destination network.

17. The apparatus of claim 15, wherein the wireless LAN control unit randomly generates a service identifier and a security key in response to a user's request that is made through the input unit and performs wireless LAN setup based on manipulation of the button by using the service identifier and the security key.

18. The apparatus of claim 15, wherein the storage unit comprises a network information management table for managing a network setup information list associated with the networked apparatuses.

19. A computer readable recording medium having recorded thereon a program for executing a wireless local area network (LAN) setting method by which a currently associated wireless network links with a network that supports a wireless security setup, the method comprising:
if it is determined that the currently associated wireless network exists, storing setup information about the currently associated wireless network; and
performing the wireless security setup of the network that supports the wireless security setup, according to the stored information about the currently associated wireless network.
